(19) United States
(12) Patent Application Publication
(10) Pub. No.: US 2011/0095943 A1
(43) Pub. Date: Apr. 28, 2011

(54) Multifrequency Receiver Intended for Satellite Location

(75) Inventors: Franck Letestu, Bourg-de-Peage (FR); Stèphane Rollet, Chabeuil (FR); Pierre-Yves Dumas, Guilherand-Granges (FR)

(73) Assignee: THALES, Neuilly-sur-Seine (FR)

(21) Appl. No.: 12/757,300

(22) Filed: Apr. 9, 2010

(30) Foreign Application Priority Data
Apr. 10, 2009 (FR) 09 01790

(51) Int. Cl. G01S 19/32

(52) U.S. Cl. 342/357.72

(57) ABSTRACT

A multifrequency receiver comprises a first receiving subsystem comprising: means for receiving at least a first and a second distinct frequency at least one of which comprises a signal containing information relating to the position of a satellite, the said receiving means comprising: a first amplification stage delivering a first filtered signal based on the signal received by the receiver; a second stage for processing each of the received frequencies; a third stage comprising a mixer and at least one local oscillator; and a fourth amplification and filtering stage making it possible to amplify the filtered signal at the output of the mixer. The second stage comprises: a first switch; means for amplifying the signals of the two channels; and a second switch making it possible to deliver the signal to the third stage.

### CROSS-REFERENCE TO RELATED APPLICATIONS

This application claims priority to foreign France patent application No. 0901790, filed on Apr. 10, 2009, the disclosure of which is hereby incorporated by reference in its entirety.

### FIELD OF THE INVENTION

The present invention relates to the field of satellite radionavigation systems and more particularly multifrequency receivers. The invention relates to receivers capable of receiving different frequencies originating from one and the same or from different satellite constellations so as to correlate information in order to determine its own position. The invention relates to the radiofrequency portion of a GNSS (Global Navigation Satellite System) receiver, to the optimization of the receiving subsystem and to the sharing of the various frequency receiving means.

### BACKGROUND OF THE INVENTION

Current GNSS receivers are capable of processing several frequency bands. Certain receivers allow a use of signals on different frequency bands and therefore have increased measurement accuracy, the latter being able to take account of the signal delay due to a passing through the ionosphere for example.

Moreover, the use of signals on several frequencies allows a GNSS receiver to withstand the interference that occurs on one frequency by receiving the signal on another frequency.

The processing of two frequency bands nowadays requires the reception of these two bands and their filtering and their transition to baseband before digitization. Each band is therefore processed in parallel by a dedicated high-frequency HF subsystem comprising filters, mixers and amplifiers specific to the characteristics of the reception band that is present in the band.

This duplication of the resources ensures the correct reception of one of the bands if the other sustains interference. Specifically, the use of several frequencies may notably allow redundancy of the information.

In the context of the development of the Galileo system, of the installation of the Russian Glonass system and of the appearance of additional frequencies on the GPS system, the use of multifrequency receivers is spreading.

Various configurations may require the use of multifrequency receivers. For example, within one and the same satellite constellation, whether they be of the GPS type on the bands L₁, L₂ and/or L₅, or whether they be of the Galileo type on the bands L₁, E₅ₐ, and/or E_{5b}, the use of dual-frequency receivers makes it possible to improve location accuracy. In another example, multifrequency receivers may be involved that are capable of receiving signals from different constellations. These receivers are called “multi-constellation receivers”, a first constellation using for example the three bands L₁, L₂ and E₆ and a second constellation using for example the three bands L₁, L₅ and E_{5b}. In the latter case, the use of several frequencies makes it possible to increase accuracy, availability and resistance to interference.

FIG. 1 describes a receiving subsystem of a dual-frequency GNSS receiver that can receive information from two GPS frequencies L₁/L₂ comprising a diplexer D making it possible to separate the signals originating from two different bands. The bands are marked L₁ and L₂ and correspond respectively to 1.5 GHz and 1.2 GHz in the example of FIG. 1. The signals of each of the frequencies L₁ and L₂ are directed respectively to two different channels. Each of the channels comprises a low-noise amplifier, of the LNA type, a filter 10, 10′ respectively centred on L₁ and on L₂ depending on the channels, a tuneable amplifier A₁, A₂ and a selective filter 11, 11′ centred respectively on L₁ and on L₂. Finally, each channel comprises a mixer and an adapted local oscillator, marked OL₁ and respectively OL₂, allowing the transition to an intermediate frequency, respectively in each channel FI₁ and FI₂. A filter 12, 12′ centred on the frequency FI₁, respectively FI₂, makes it possible to deliver the filtered signal to a tuneable amplifier A₂, A₂′ delivering an amplified signal to a selective filter 13, respectively 13′. Finally, at the end of each channel, a analogue-digital converter, marked ADC, makes it possible to deliver a digital data stream to a correlator C. The correlator C makes it possible to pursue the digital signal transmitted by the satellite and makes it possible to indirectly estimate a pseudo-distance between a satellite and the receiver.

This type of receiver can be generalized to any type of dual-frequency receiver using other frequency bands.

Another embodiment of a GNSS receiver of the prior art makes it possible to process three different frequencies. In the example of FIG. 2, a GNSS receiver can receive the three bands marked L₁, L₂ and E₆ corresponding to bands used for satellite location.

The architecture of the receiver of FIG. 2 comprises two portions of which one portion is substantially identical to the architecture of FIG. 1 and the other portion is an additional reception channel. A triplexer can be used or produced for example by having two cascaded diplexers D₁, D₂. The architecture of FIG. 2 is based on the fact that two of the three bands are close together. In the case of the example of FIG. 2, the two close bands are the bands E₆ and L₂. In the case of a Galileo multifrequency receiver, these two bands would be replaced by the bands E₅ₐ and E_{5b}.

In this situation, the embodiment makes it possible for these two bands to share the low-noise amplifier (LNA).

This example is notably possible because the closeness of the bands L₂ and E₆ or E₅ₐ and E_{5b} is sufficient to use at the head of the receiver a diplexer D₁ instead of a triplexer.

Drawbacks of current multifrequency receivers lie in the complexity of the various receiving subsystems, the bulk of these subsystems and the redundancy of certain components in the various reception channels.

### SUMMARY OF THE INVENTION

The invention makes it possible to alleviate the aforementioned drawbacks.

So as not to multiply the HF resources as in proportion to the number of frequencies processed, the invention makes it possible to share certain elements of the HF portion of a multifrequency receiver.

This type of architecture is also of great value for the multi-antenna receivers that have to multiply this number of channels by the number of antennas used.

The invention makes it possible to reduce the complexity and the cost while maintaining performance at reception level of the received signals.

The invention makes it possible to miniaturize the receivers and facilitate the integration of the functionalities.

Advantageously, the multifrequency receiver comprises a first receiving subsystem comprising:
means for receiving at least a first and a second distinct frequency at least one of which comprises a signal containing information relating to the position of a satellite, the said receiving means comprising:
   a first amplification stage comprising at least one low-noise amplifier delivering a first filtered signal based on the signal received by the receiver;
   a second stage for processing each of the received frequencies;
   a third stage comprising a mixer and at least one local oscillator allowing the transition from a received frequency to a first intermediate frequency;
   a fourth amplification and filtering stage comprising at least one tuneable amplifier making it possible to amplify the filtered signal at the output of the mixer and supported by the first intermediate frequency, and at least one filter making it possible to filter the first intermediate frequency.

Advantageously, the second stage comprises:
a first switch delivering the signal originating from the first stage alternately into two channels according to each of the received frequencies, each of the channels comprising means for filtering each of the frequencies;
means for amplifying the signals of the two channels;
a second switch making it possible to deliver the signal to the third stage.

Advantageously, the filtering means of the second stage comprise a first set of filters making it possible to filter the signals originating from the low-noise amplifier of the first stage and a second set of filters making it possible to filter the signals amplified by the amplification means of the second stage.

Advantageously, the amplification means comprise:
a switch making it possible to switch the signals originating from the first set of filters of the second stage;
a shared tuneable amplifier amplifying the signals originating from each of the channels connected to the said switch;
a switch making it possible to switch the signals amplified by the shared tuneable amplifier and delivering the amplified signals to the second set of filters of the second stage.

Advantageously, the first receiving subsystem comprises a preliminary filtering stage comprising a band-pass filter allowing the reception of at least two frequency bands.

Advantageously, the first receiving subsystem of the receiver comprises a first analogue/digital converter making it possible to digitize the amplified and filtered signal of the first intermediate frequency.

Advantageously, the receiver comprises a computer, marked correlator C, making it possible to pursue the digital signal transmitted by the satellite.

Advantageously, the first frequency is included in the band L₁ and the second frequency is included in the band L₂.

Advantageously, a diplexer and a second receiving subsystem comprise means for receiving a third frequency. The diplexer delivers a first signal supported by the first frequency and the second frequency in the first receiving subsystem and delivers a second signal supported by the third frequency in a second receiving subsystem, the said second receiving subsystem comprising:
an amplification stage comprising at least one low-noise amplifier delivering a first filtered signal based on the second signal received by the receiver;
a filtering stage comprising a tuning amplifier and at least one filter;
a mixer and at least one local oscillator allowing the transition from a received frequency to a second intermediate frequency;
an amplification and filtering stage comprising at least one tuneable amplifier making it possible to amplify the filtered signal at the output of the mixer and supported by the second intermediate frequency, and at least one filter making it possible to filter the intermediate frequency.

Advantageously, the second receiving subsystem of the receiver comprises a second analogue/digital converter making it possible to digitize the amplified and filtered signal of the second intermediate frequency.

Advantageously, the computer, marked correlator, makes it possible to detect transmission errors of one of the two receiving subsystems.

Advantageously, the first frequency is included in the band E₅ₐ, and the second frequency is included in the band E_{5b} and the third frequency is included in the band L₁.

Advantageously, the first frequency is included in the band L₂, and the second frequency is included in the band E₆ and third frequency is included in the band L₁.

### BRIEF DESCRIPTION OF THE DRAWINGS

Other features and advantages of the invention will appear with the aid of the following description made with respect to the appended drawings which represent:

FIG. 1: a dual-frequency receiver of the prior art comprising two reception channels;

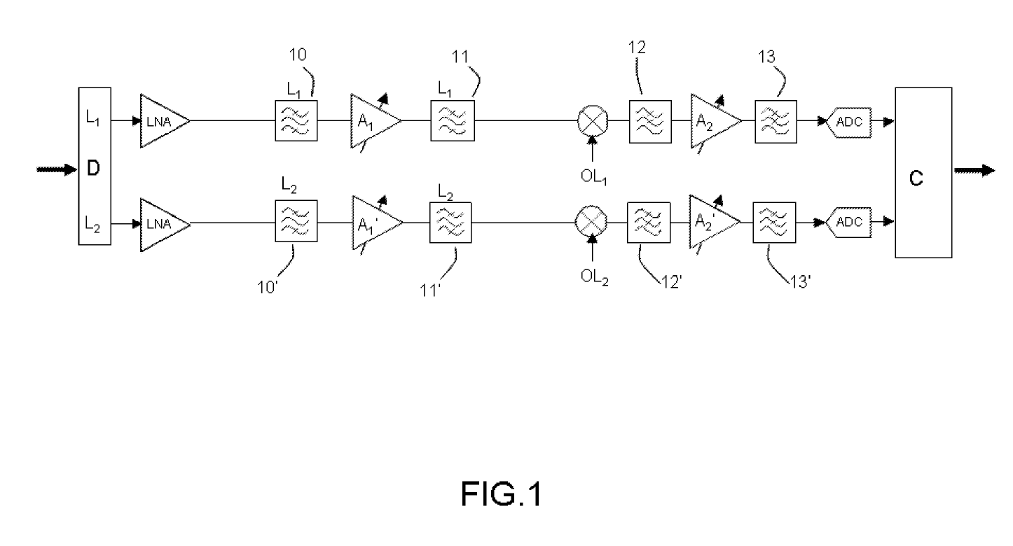

FIG. 2: a three-frequency receiver of the prior art comprising three reception channels;

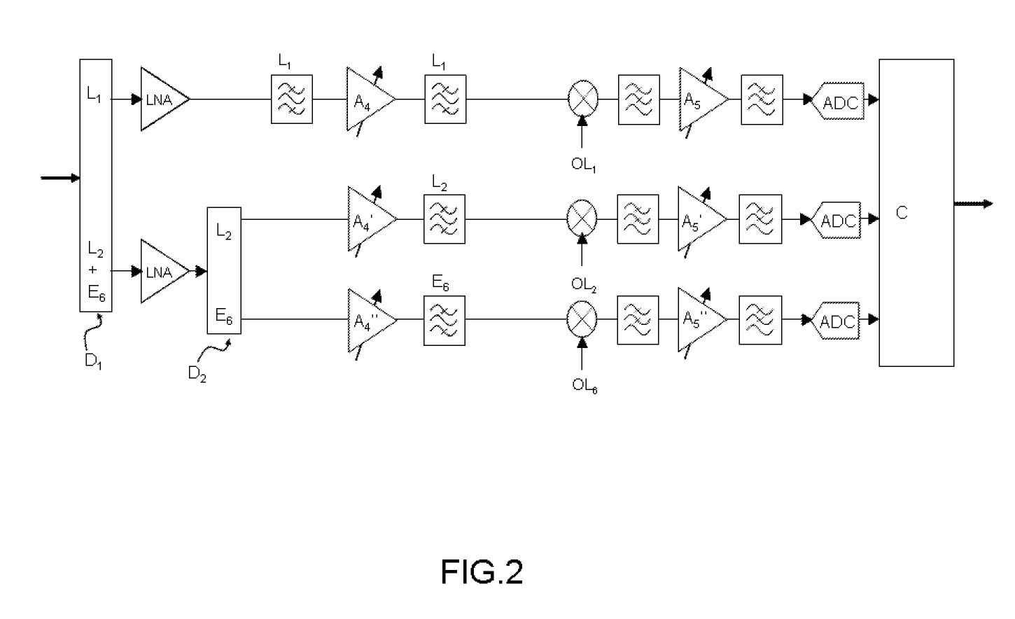

FIG. 3: an exemplary embodiment of a dual-frequency GNSS receiver according to the invention;

FIG. 4: an exemplary embodiment of a three-frequency GNSS receiver according to the invention;

FIG. 5: an exemplary embodiment of a three-frequency GNSS receiver according to the invention using signals of different constellations;

FIG. 6: a second embodiment of a dual-frequency receiver according to the invention;

FIG. 7: a second embodiment of a three-frequency receiver according to the invention;

FIG. 8: a second embodiment of a three-frequency receiver according to the invention using signals of different constellations.

### DETAILED DESCRIPTION OF THE INVENTION

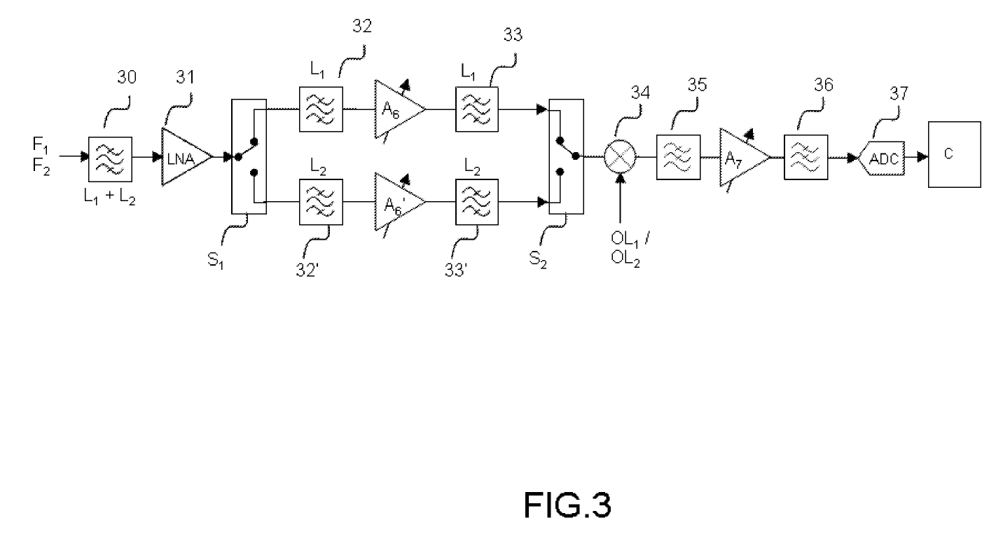

FIG. 3 represents a first embodiment of the invention.

A receiving subsystem comprises a band-pass filter 30 making it possible to receive and process two frequencies F₁ and F₂. In the example of FIG. 3, the two frequencies F₁ and F₂ are associated with two bands respectively the band L₁, corresponding to a band around 1.5 GHz, and the band L₂, corresponding to a band around 1.2 GHz.

A low-noise amplifier 31 which may for example be an LNA as shown in the example of FIG. 3, makes it possible to amplify the output signals of the filter 30.

A first switch makes it possible to direct the amplified signals according to two channels.

A first channel comprises:
a filter 32 making it possible to transmit the signals of the band L₁ in the first channel;
a tuneable amplifier A₆ making it possible to amplify the signals filtered by the filter 32;
a selective filter 33 making it possible to deliver filtered signals after amplification.

The second channel comprises:
a filter 32′ making it possible to transmit the signals of the band L₂ in the first channel;
a tuneable amplifier A₆′ making it possible to amplify the signals filtered by the filter 32;
a selective filter 33′ making it possible to deliver filtered signals after amplification.

Finally, in the receiving subsystem of the GNSS receiver, a second switch S₂ makes it possible to cause alternately the signals of the first and the second channel to converge towards a mixer 34.

The mixer 34 makes it possible to mix respectively the signals of the bands L₁ and L₂ with a clock frequency originating respectively from a first local oscillator OL₁ and a second local oscillator OL₂.

A switch not shown makes it possible to pass from a clock frequency of the first local oscillator OL₁ to a clock frequency of the second local oscillator OL₂.

In a particular embodiment, the invention makes is possible to have a single clock frequency comprising a common period generating the desired intermediate frequencies.

At the output of the mixer, an intermediate frequency FI₁ or FI₂ is obtained, depending on whether the signals of the band L₁ are mixed with the local clock OL₁ or whether the signals of the band L₂ are mixed with the local clock OL₂.

A filter 35 makes it possible to filter the signals other than the intermediate frequencies FI₁ or FI₂ to a tuneable amplifier A₇; the tuneable amplifier makes it possible to deliver an amplified signal to another selective filter 36.

The use of a tuneable or variable amplifier makes it possible to alleviate the problems of drift and makes it possible to homogenize the output level of the signals at the end of the receiving subsystem.

At the end of the receiving subsystem, an analogue/digital converter, marked in the example ADC, makes it possible to deliver a digital data stream to one or more correlators C.

The correlator C makes it possible to pursue the digital signal transmitted by the satellite and makes it possible indirectly to estimate a pseudo-distance between a satellite and the receiver.

In various embodiments, the correlator may be produced based on an ASIC or an FPGA for example.

Advantageously, the invention makes it possible to combine components of the receiving subsystem so as to simplify the architecture, reduce the bulk and reduce the costs.

In the example of FIG. 3, in comparison with a conventional receiving subsystem of the prior art, the invention has made it possible to share a low-noise amplifier, a mixer and a set of components comprising filters and amplifiers.

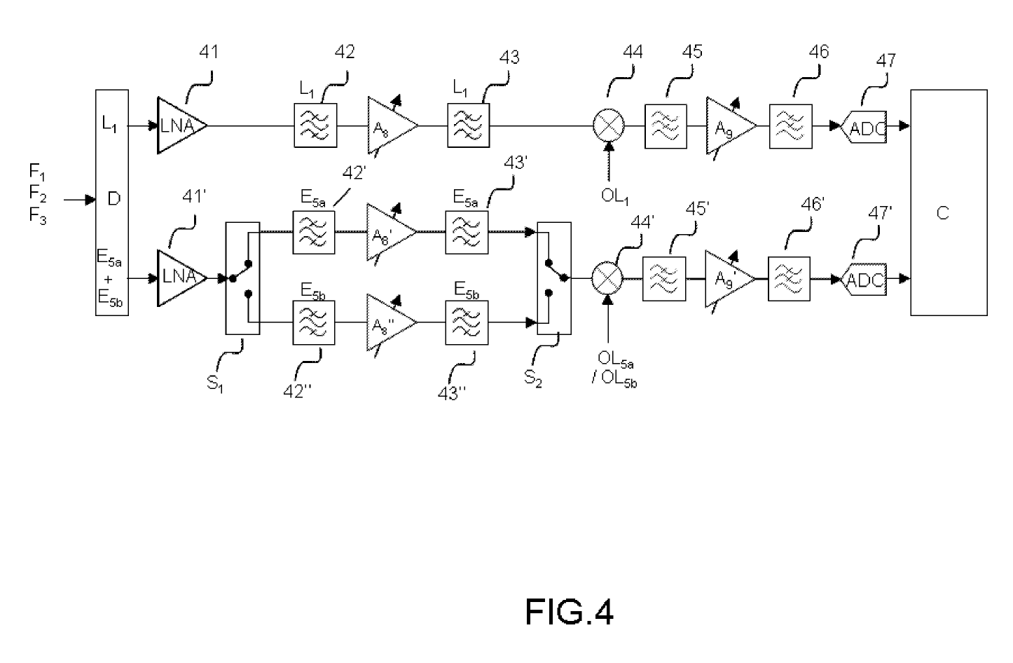

FIG. 4 represents a variant embodiment of a multifrequency GNSS receiver comprising notably means for receiving three distinct frequencies included in the bands commonly called L₁, E₅ₐ and E_{5b}.

A diplexer D makes it possible to direct the received frequencies depending on their reception band. Notably, in this embodiment, the bands E₅ₐ and E_{5b} being sufficiently close together, the received frequencies belonging to one of these two bands are directed to a low-noise amplifier 41′, of the LNA type. The signals supported by the frequencies in the band L₁ are routed by means of the diplexer to a low-noise amplifier 41.

The signals leaving the amplifier 41′ are directed to a receiving subsystem substantially similar to that of FIG. 3 give or take the characteristics of the components which are suited to the reception frequencies with respect to the filtering stages 42′, 42″, 43′, 43″, 45′ and 46′, amplification stages A₈′, A₈″, A₉′, the mixer 44′ and the analogue/digital converter 47′.

The signals leaving the amplifier 41 are routed to a reception channel comprising:
a filter 42 making it possible to transmit the signals of the band L₁ into the first channel;
a tuneable amplifier A₈ making it possible to amplify the signals filtered by the filter 42;
a selective filter 43 centred on the band L₁ making it possible to deliver the filtered signals after amplification;
a mixer 44 comprising a local oscillator OL₁ making it possible to deliver, after mixing with the signals originating from the filter 43, an intermediate frequency;
a tuneable amplifier A₉;
a selective filter 46 and an analogue/digital converter 47.

At the end of the subsystem, a correlator C makes it possible to correlate the signals originating from the two converters 47 and 47′.

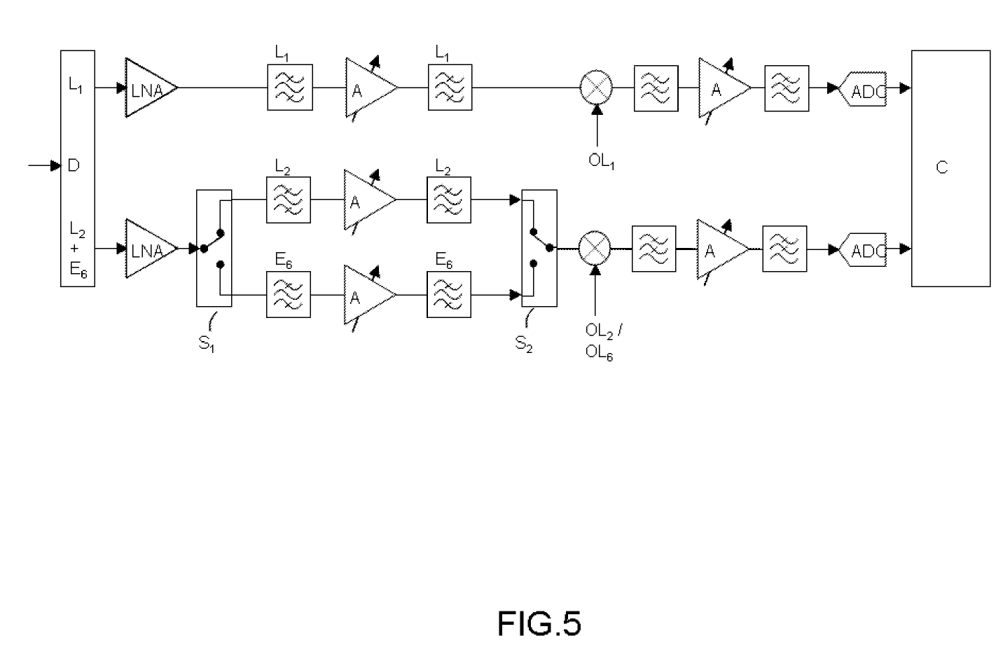

FIG. 5 represents a variant embodiment similar to FIG. 4 in which the diplexer separates on the one hand the signals received in the band L₁ and on the other hand the signals received in the bands L₂ and E₆.

This solution is suitable for receiving signals originating from two different constellations, such as that delivering the GPS signal and Galileo.

The architecture is substantially similar to that of FIG. 4 give or take the features of the components.

An advantage of the invention is the use of switches and of the switching frequency between the various channels.

Notably, there is an advantage in the computation of the ionospheric corrections that are carried out at regular intervals but that do not require the continuous reception of a signal.

The architectures according to the invention of FIGS. 4 and 5 comprise many advantages:

A first advantage is increased accuracy due to computing the ionospheric corrections irrespective of the constellation. According to the embodiments, switching between the frequencies L₂ and E₆ or between the frequencies E₅ₐ and E_{5b} or between the frequencies L₁ and L₂ at regular intervals makes it possible to make the computations of the ionospheric corrections on one of the two frequencies. Specifically, the pursuit of the two frequencies continuously is not necessary to compute the ionospheric corrections.

A second advantage is making possible the retention of the best possible availability in the event of interference on a band. The invention allows a switching mode so as to choose the least affected frequency between L₂ and E₆, respectively according to the embodiments, between E₅ₐ and E_{5b} or between L₁ and L₂.

A third advantage of the invention is that it allows the use of filters of the same bandwidth on L₂ and E₆, respectively according to the embodiments between E₅ₐ and E_{5b} or between L₁ and L₂. Notably, the use of filters having the same bandwidths makes it possible to not add constraints on the sampler of the switch.

The invention makes it possible to maintain the rejection and linearity performance of the embodiments described in comparison with the performance of a conventional architecture comprising as many reception channels as received frequencies.

The use of a diplexer, such as that described in FIG. 4 or 5, covering on the one hand the band L₁ and on the other hand the bands L₂ and E₆, and respectively in another embodiment the bands E₅ₐ and E_{5b}, does not harm the performance in comparison with the embodiment of FIG. 3 in which a diplexer makes it possible to cover the bands L₁ and L₂, or in another embodiment not described, the bands L₁ and L₅.

Specifically, in terms of rejection, the first low-noise amplifier has sufficient linearity to absorb the differences in decibels lost in rejection.

The constraints of linearity lie mainly on the secondary RF amplifiers and on the stage for processing the intermediate frequency FI. For these components, the switch and the filters ensure sufficient isolation.

Finally, in terms of development risks, the physical segregation of the channels makes it possible to minimize the influence of E₆ on L₂ in the example of FIG. 5 and of E₅ₐ on E_{5b} in the example of FIG. 4 and of L₁ on L₂ in the example of FIG. 3.

Another advantage lies in the fact that the analogue channels processing the intermediate frequencies FI are isolated from one another because only one channel is activated at a given time.

A variant embodiment of the invention proposes to share other components, such as the tuning amplifiers, of each of the channels.

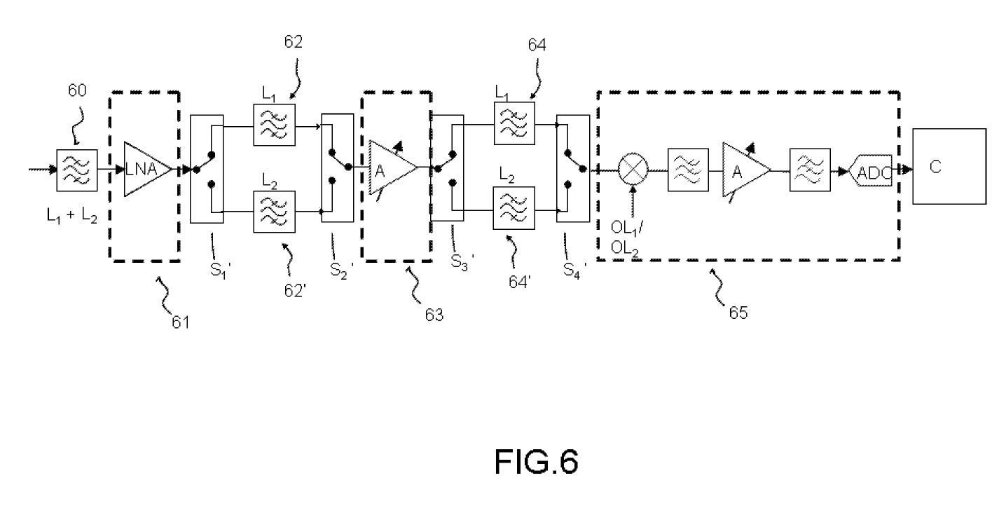

FIG. 6 represents an embodiment of the invention that is substantially similar to the case of FIG. 3. The GNSS receiver, in the example of FIG. 6, can receive the frequencies of the bands L₁ and L₂.

A band-pass filter 60 makes it possible to centre the signals to be processed of the bands L₁ and L₂, a low-noise amplifier 61, of the LNA type, amplifies the signals before directing them to switch S₁′. The switch S₁′ directs the received signals according to two channels 62, 62′, each of the channels comprising a filtering stage. A second switch S₂′ makes it possible to cause the filtered signals to converge on a tuneable amplifier A. The latter amplifier is shared and makes it possible to amplify the signals originating from each of the channels.

Finally, a third switch S₃′ makes it possible to separate each of the signals to be transmitted into two separate channels 64 and 64′. Each of the channels 64 and 64′ comprises a filtering stage. The filtered signals are then transmitted to a fourth switch S₄′ which makes it possible to transmit the signals of each of the channels 64 and 64′ to a mixer.

The last stage 65 of the receiving subsystem of the GNSS receiver is identical to that of FIG. 3.

An advantage of this embodiment is that it makes it possible to use RF ASICs containing components such as amplifiers, local oscillators (OL) and FI filters while using external RF filters.

Therefore only the RF filters are duplicated in this embodiment, the rest of the subsystem being shared.

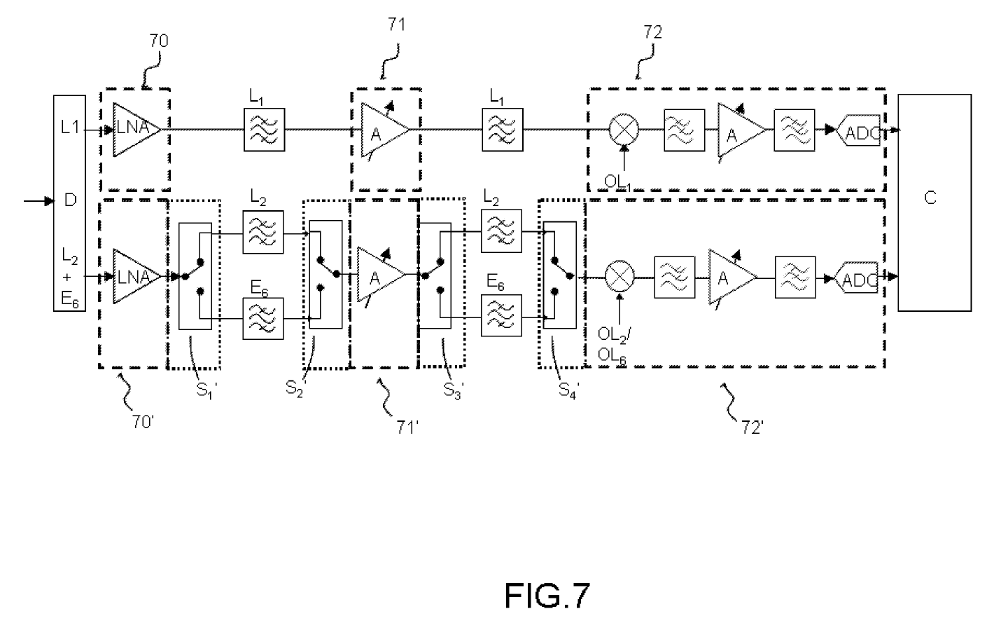

FIG. 7 represents an embodiment similar to that of FIG. 4. The three-frequency GNSS receiver makes it possible to receive, in this example, frequencies contained in the bands L₁, L₂ and E₆.

A diplexer D makes it possible to separate on the one hand the signals included in the band L₁ and on the other hand the signals included in the bands L₂ and E₆.

A first channel routing the signals included in the band L₁ in the receiving subsystem comprises stages 70, 71 making it possible to amplify the filtered signals, and a stage 72 making it possible to process the intermediate frequency specific to the channel L₁.

A second channel routing the signals included in the bands L₂ and E₆ is substantially similar to the receiving subsystem of FIG. 6. It comprises two amplification stages making it possible to share the amplification means of the received signals of each of the channels processing the signals L₂ and processing the signals E₆.

Finally, a final stage 72′ makes it possible to process the intermediate frequencies of the receiving subsystem.

A switch not shown in the figure makes it possible to alternate the transmission of the local oscillators OL₂ and OL₆ in the mixer.

Only two RF ASICs become necessary instead of three in the case of a three-frequency receiver, only one ASIC in the case of a dual-frequency receiver.

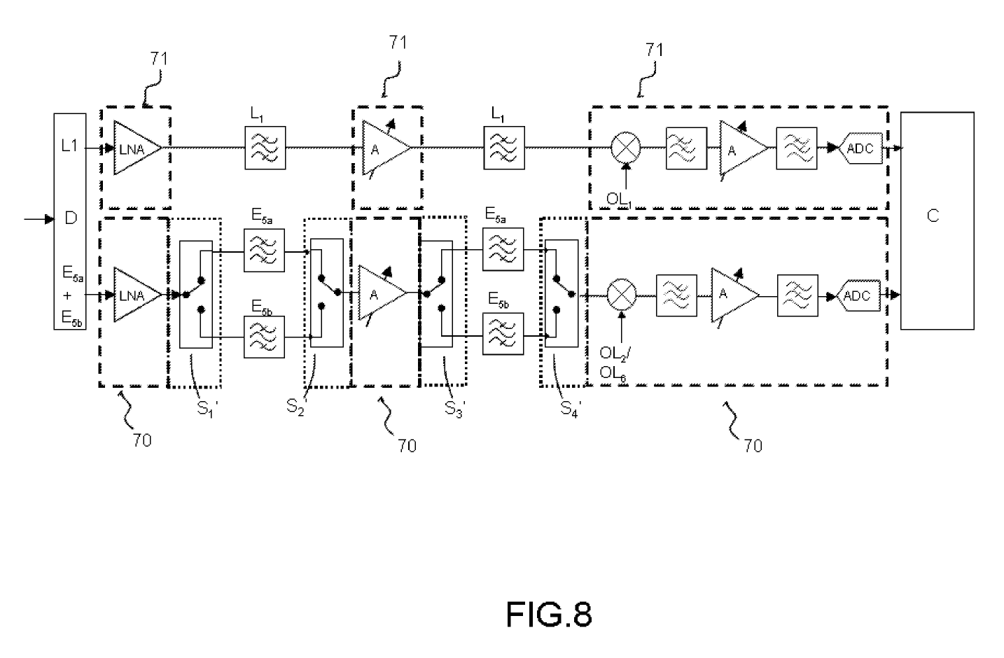

Finally, another variant embodiment is shown in FIG. 8 and deals with the specific case of receiving signals originating from different constellations, of the GPS or Galileo type for example.

In this latter case, the architecture is similar to that of FIG. 7 except for the components adapted to the frequency bands specific to this embodiment.

A duplexer makes it possible to separate on the one hand the signals included in the band L₁ and on the other hand the signals included in the bands E_{5A} and E_{5B}.

A final embodiment of the invention, not shown, also makes it possible to integrate the switches into the ASIC component so as to have only the RF filters as external components.

These architectures therefore make it possible to simultaneously receive N−1 frequencies out of N frequencies with, except for the RF filters, the components necessary to receive only N−1 frequencies.

The architecture of the invention can be extended to a large number of reception frequencies.

One of the main advantages of the invention lies in the diversity of the various solutions that the use of the switches allows, notably with respect to their sampling frequency.

The choice notably of the times and of the frequency of transition between the switched frequencies allows many uses of a GNSS receiver according to the invention.

The switching of all the switches, for example of the switches S₁ and S₂ of FIGS. 3, 4 and 5 or of the switches S₁′, S₂′, S ₃′, S₄′ of FIGS. 6, 7 and 8 of a receiving subsystem is synchronized so as to retain the integrity of the received signals in each reception channel.

A first embodiment allows switching “on demand” of the switches.

In the case of an architecture of a three-frequency receiver, comprising for example frequency reception channels included in the bands L₁, E₆ and L₂, a standard method of use is reception on the bands L₁ and L₂. Switching on the band E₆ can be applied when interference occurs on the band L₂. In this embodiment, the invention ensures resistance to interference by switching over to a frequency that is always available.

The switchover or switching, depending on the embodiments of the invention, can be carried out by a manual action of an operator or automatically detected by a computer depending on the corruption of the signals received in the band L₂.

In the case of an architecture of a three-frequency receiver, comprising for example frequency reception channels included in the bands L₁, E₅ₐ and E_{5b} used for civil aviation applications, the switching can be carried out during changes in flight phases.

For example, the bands L₁ and E₅ₐ in the cruising flight phase so as to take advantage of the greater width of the band E₅ₐ then, during the approach phase in which the integrity information present on E_{5b} is crucial, switch to the bands L₁ and E_{5b}.

Another embodiment of the invention allows regular switching of the low-frequency switches.

A method comprising regular switching can be envisaged in certain situations. It makes it possible to take advantage of one frequency and then the other alternately. Therefore one switching frequency of a second for example makes it possible to ensure the pursuit of both switched frequencies and to take advantage alternately of the ionospheric corrections on one and then the other frequency.

Another embodiment of the invention allows regular switching of the switches at high frequency.

A more rapid switching frequency of the order of 100 μs for example makes it possible to ensure the pursuit in parallel of both switched frequencies. This switching time remains sufficiently short to allow the demodulation of the data bits on each channel. In most applications, the time to transmit a data bit is substantially close to a few milliseconds.

The disadvantage of switching is the loss of 3 dB in signal-to-noise ratio on each channel because the signal is available only half of the time. This operation also requires perfect synchronization of the processing portion of the signal with the switching moments of the HF subsystem, and appropriate processing algorithms.

This type of architecture with frequency switching can be envisaged in fields as diverse as the reception of radiocommunication signals, radar or multi-antenna processing with a large number of HF channels.

One advantage of the architectures according to the invention is that their operating mode provides a reduction in cost and in space requirement of the HF receiving subsystem of a multifrequency GNSS receiver while maintaining optimal performance.

The invention makes it possible to retain the qualities of an N-frequency system from a point of view of GNSS usage while having an HF architecture suited to the reception of only N−1 frequencies.

What is claimed is:

1. A multifrequency receiver comprising a first receiving subsystem, comprising:
means for receiving at least a first frequency and a second distinct frequency at least one of which comprises a signal containing information relating to the position of a satellite, the said receiving means further comprising:
a first amplification stage comprising at least one low-noise amplifier delivering a first filtered signal based on the signal received by the receiver;
a second stage for processing each of the received frequencies;
a third stage comprising a mixer and at least one local oscillator allowing the transition from a received frequency to a first intermediate frequency; and
a fourth amplification and filtering stage comprising at least one tuneable amplifier making it possible to amplify the filtered signal at the output of the mixer and supported by the first intermediate frequency, and at least one filter making it possible to filter the first intermediate frequency,
wherein the second stage further comprises:
a first switch delivering the signal originating from the first stage alternately into two channels according to each of the received frequencies, each of the channels comprising means for filtering each of the frequencies;
means for amplifying the signals of the two channels; and
a second switch making it possible to deliver the signal to the third stage.

2. A multifrequency receiver according to claim 1, wherein the filtering means of the second stage comprise a first set of filters making it possible to filter the signals originating from the low-noise amplifier of the first stage and a second set of filters making it possible to filter the signals amplified by the amplification means of the second stage.

3. A multifrequency receiver according to claim 2, wherein the amplification means further comprise:
a switch making it possible to switch the signals originating from the first set of filters of the second stage;
a shared tuneable amplifier amplifying the signals originating from each of the channels connected to the said switch;
a switch making it possible to switch the signals amplified by the shared tuneable amplifier and delivering the amplified signals to the second set of filters of the second stage.

4. A multifrequency receiver according to claim 1, wherein the first receiving subsystem comprises a preliminary filtering stage comprising a band-pass filter allowing the reception of at least two frequency bands.

5. A multifrequency receiver according to claim 1, wherein the first receiving subsystem of the receiver comprises a first analogue/digital converter making it possible to digitize the amplified and filtered signal of the first intermediate frequency.

6. A multifrequency receiver according to claim 3, wherein the receiver comprises a computer, marked correlator, making it possible to pursue the digital signal transmitted by the satellite.

7. A multifrequency receiver according to claim 4, wherein the first frequency is included in the first band and the second frequency is included in the second band.

8. A multifrequency receiver according to claim 1, further comprising a diplexer and a second receiving subsystem comprising means for receiving a third frequency, wherein the diplexer delivers a first signal supported by the first frequency and the second frequency in the first receiving subsystem and delivers a second signal supported by the third frequency in a second receiving subsystem, the said second receiving subsystem further comprising:
an amplification stage comprising at least one low-noise amplifier delivering a first filtered signal based on the second signal received by the receiver;
a filtering stage comprising a tuning amplifier and at least one filter;
a mixer and at least one local oscillator allowing the transition from a received frequency to a second intermediate frequency; and
an amplification and filtering stage comprising at least one tuneable amplifier making it possible to amplify the filtered signal at the output of the mixer and supported by the second intermediate frequency, and at least one filter making it possible to filter the intermediate frequency.

9. A multifrequency receiver according to claim 8, wherein the second receiving subsystem of the receiver further comprises a second analogue/digital converter making it possible to digitize the amplified and filtered signal of the second intermediate frequency.

10. A multifrequency receiver according to claim 8, wherein the computer, marked correlator (C), makes it possible to detect transmission errors of one of the two receiving subsystems.

11. A multifrequency receiver according to claim 8, wherein the first frequency is included in the band E₅ₐ, the second frequency F₂ is included in the band E_{5b} and third frequency F₃ is included in the band L₁.

12. A multifrequency receiver according to claim 8, wherein the first frequency is included in the band L₂, the second frequency F₂ in is included in the band E₆ and the third frequency is included in the band L₁.
